(19) United States
(12) Patent Application Publication
(10) Pub. No.: US 2008/0284877 A1
(43) Pub. Date: Nov. 20, 2008

(54) Camera Color Noise Reduction Method and Circuit

(75) Inventor: Cornelis Antonie Maria Jaspers, Hapert (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/571,528

(22) PCT Filed: Jun. 28, 2005
(86) PCT No.: PCT/IB05/52146

§ 371 Date: Jan. 2, 2007

(30) Foreign Application Priority Data
Jul. 5, 2004 (EP) 04103173.3

(51) Int. Cl. H04N 5/217

(52) U.S. Cl. 348/241; 348/E09.037

(57) ABSTRACT

Image color noise reduction circuit (20) and image processing method for processing a digital image having primary color signals (R; G; B). A determination circuit (27) determines a maximum signal value (Signaltype) from the primary color signals. A calculation circuit (29) connected to the determination circuit (27) reduces a color saturation of the digital image by modifying the primary color signals or signals related thereto depending on the maximum signal value. The color saturation is reduced at least for low values of the primary color signals or signals related thereto.

### FIELD OF THE INVENTION

The present invention relates to a method for reducing color noise in a digital image having primary color signals. In a further aspect, the present invention relates to an image color noise reduction circuit for processing a digital image, e.g. from a camera, having primary color signals.

### BACKGROUND OF THE INVENTION

Japanese patent publication JP-A-2001-197508 describes an electronic camera, in which noise is suppressed. For this, the primary color signal from the sensor is processed to obtain a luminance signal and a chrominance signal. Both the luminance signal and the chrominance signal are subjected to high frequency attenuation means to attenuate high frequency components of these signals. Furthermore, the attenuated chrominance signal is processed to adjust the saturation of the attenuated chrominance signal. This electronic camera requires complex filtering circuitry to obtain a low noise output image.

American patent application US2001/0048476 describes a picture signal processing apparatus for level compressing high luminance portions of picture signals. The primary color signals of a digital image are processed in parallel for each primary color by changing the saturation of the high luminance portion to obtain an improved luminance compression. Image noise, especially color noise, is not suppressed in this apparatus.

### SUMMARY OF THE INVENTION

The present invention seeks to provide a solution to the problem of reducing color noise which arises especially in parts of the digital image with low light conditions. Especially in present day CMOS sensors, this may result in images in which noise is visible not only as black and white noise, but also as colored noise.

According to the present invention, a method according to the preamble defined above is provided, in which the method comprises determining a maximum signal value (Signaltype) from the primary color signals, and reducing a color saturation of the digital image by modifying the primary color signals or signals related thereto (such as color difference signals, R—Y, G—Y, B—Y, Y being the luminance value) depending on the maximum signal value, in which the color saturation is reduced at least for low values of the primary color signals or signals related thereto. The maximum signal value may e.g. be the maximum value of the primary color signal having R-, G-, and B-components, or the maximum value multiplied by a factor, which factor may depend on the applied white balance correction.

This method allows to reduce the color noise in a (digital) image without any complex processing required, such as 2D or 3D filtering techniques. Although the color saturation at low intensity levels will be somewhat less, proper choice of operational parameters can provide a high quality image with reduced color noise. It is noted that by applying the saturation reduction to the primary color signals only, no influence is present on other image characteristics, such as the luminescence of the image.

In a further embodiment of the present method, modifying the primary color signals or signals related thereto comprises multiplying with a fading factor (satfading), in which the fading factor is a function dependent on the maximum signal value, determined by:

satfading=1−((uppersignallevel−Signaltype)/(uppersignallevel−lowersignallevel)), if the maximum signal value Signaltype is smaller than uppersignallevel and larger than lowersignallevel;

and by

satfading=0, if the maximum signal value Signaltype is lower than or equal to lowersignallevel,

in which uppersignallevel is a predetermined upper level where de-saturation and color noise reduction starts, and lowersignallevel is a predetermined lower level where saturation and color noise have become zero.

By properly choosing the parameters uppersignallevel and lowersignallevel, a good quality image is obtainable having a much less pronounced presence of color noise. When the primary color signals are provided with a value range of 0 . . . 255, the uppersignallevel may be 160, and the lowersignallevel may be 60 to obtain high quality color noise reduced images.

In a further embodiment of the present invention, the fading factor is multiplied with an additional multiplier factor. When choosing the value zero for the multiplier factor, a mere black and white picture will be obtained such as e.g. used for night shot capability. Also, the multiplier factor may be chosen to be larger than unity (>1) in order to increase color saturation at low camera noise.

When taking the value of the parameter uppersignallevel to be larger than a maximum possible primary color signal level in a further embodiment, it is possible to obtain color saturation correction at all times.

When taking the value of the parameter lowersignallevel to be smaller than a minimum possible primary color signal level in an even further embodiment, it is possible to prevent obtaining a totally gray image at low saturation levels.

As mentioned before, the primary color signals may be of the RGB type. Then, in a further embodiment, the maximum signal value is a maximum value (RGBmax) of the primary color signals. This embodiment is easy to implement, without requiring very much processing capability, and can provide a very adequate color noise suppression in digital images.

In a further, more sophisticated embodiment, the maximum signal value is again a maximum value RGBmax of the primary color signals, but then multiplied by a white balance signal factor. By incorporating a correction depending on the white balance processing of the image, an even more efficient and well balanced color noise reduction may be obtained. The signal factor may e.g. be equal to 1/wbR if red has the highest primary color signal value or 1/wbB if blue has the highest primary color signal value, in which wbR and wbB are parameters used in the image processing to obtain a correct white balance.

The correction dependent on the white balance processing may be implemented in an even better way in a further embodiment, in which

in case of a white balance correction of the image to a lower color temperature, the white balance signal factor is equal to:

one if the maximum value RGBmax of the primary color signals is the green component signal G;
Bluegain if the maximum value RGBmax of the primary color signals is the blue component signal B; and
1/Redgain if the maximum value RGBmax of the primary color signals is the red component signal R;

in case of a white balance correction of the image to a higher color temperature the white balance signal factor is equal to:

one if the maximum value RGBmax of the primary color signals is the green component signal G;
1/Bluegain if the maximum value RGBmax of the primary color signals is the blue component signal B; and
Redgain if the maximum value RGBmax of the primary color signals is the red component signal R;

and in case of no white balance correction, the white balance signal factor is equal to one (unity);

in which Bluegain and Redgain are parameters depending on the primary color signals and white balance correction parameters for obtaining a smooth adaptation of the color noise reduction.

As indicated in this embodiment, no correction is applied when the green component of the primary color signal has the maximum value. When either the red or blue component is the maximum value part of the primary color signals, the correction factor depends on how the white balance is adapted for the particular image.

In further embodiments, the parameter Bluegain is calculated according to:

if G>=R then Bluegain=1+(deltabluegain×RGBsat×(RGBmax−G)/RGBmax);
if B>G then Bluegain=1+(deltabluegain×RGBsat×(RGBmax−B)/RGBmax);
in which R, G and B are the color signal values in the white-cyan-magenta triangle of the three dimensional color space,
RGBsat is a saturation parameter according to RGBsat=(RGBmax−RGBmin)/RGBmax, in which RGBmax is the maximum value in the primary color signals (in this case the blue component) and RGBmin is the minimum value in the primary color signal, and deltabluegain is a predetermined parameter.

Furthermore, the parameter Redgain may be calculated according to:

if G>=R then Redgain=1+(deltaredgain×RGBsat×(RGBmax−G)/RGBmax);
if B>G then Redgain=1+(deltaredgain×RGBsat×(RGBmax−R)/RGBmax);
in which R, G and B are the color signal values in the white-yellow-magenta triangle of the three dimensional color space,
RGBsat is a saturation parameter according to RGBsat=(RGBmax−RGBmin)/RGBmax, in which RGBmax is the maximum value in the primary color signal (in this case the red component) and RGBmin is the minimum value in the primary color signal, and deltaredgain is a predetermined parameter.

The parameters deltabluegain and deltaredgain are in this case determined by white balance parameters already used in the image processing, or by white balance parameters with an additional correction factor. Alternatively, the parameters deltabluegain and deltaredgain may be chosen based on an empirical determination.

The method according to these embodiments provides for a very smooth color saturation transient at the borders between the dominating red and blue color areas in the three dimensional color space. It is noted that these smooth transitions may be applied as well in other image processing methods.

In a further aspect, the present invention relates to an image color noise reduction circuit for processing a digital image, e.g. from a camera, having primary color signals, the image color noise reduction circuit comprising:

a determination circuit for determining a maximum signal value (Signaltype) from the primary color signals and a calculation circuit connected to the determination circuit for reducing a color saturation of the digital image by modifying the primary color signals or signals related thereto (e.g. color difference values) depending on the maximum signal value, in which the color saturation is reduced at least for low values of the primary color signals or signals related thereto.

In further embodiments, the calculation circuit and/or the determination circuit is further arranged for executing the present method.

In an even further embodiment the image color noise reduction circuit further comprises a calculator element receiving input parameters from the determination circuit and outputting parameters to the calculation circuit, in which the determination circuit, calculator element and calculation circuit are arranged to execute the method according to embodiments of the present method.

In an even further aspect, the present invention relates to a digital camera comprising a digital image sensor, processing electronics for processing the digital image from the digital image sensor and an image color noise reduction circuit according to one of the embodiments of the present invention.

### BRIEF DESCRIPTION OF DRAWINGS

The present invention will be discussed in more detail below, using a number of exemplary embodiments, with reference to the attached drawings, in which

FIG. 1 shows a block diagram of a digital camera in which embodiments of the present invention may be applied;

FIG. 2 shows a detailed block diagram of a first embodiment of the color noise reduction circuit according to the present invention; and

FIG. 3 shows a detailed block diagram of a further embodiment of the color noise reduction circuit according to the present invention.

### DESCRIPTION OF EXEMPLARY EMBODIMENTS

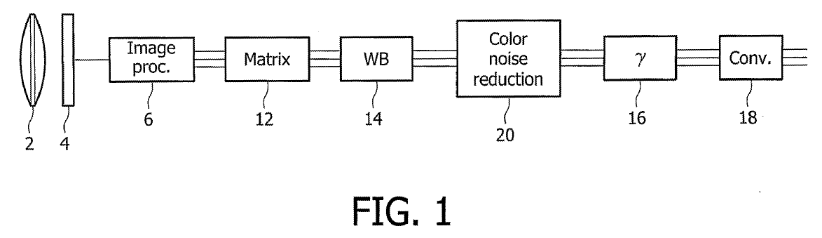

FIG. 1 shows a block diagram of a digital camera as an exemplary apparatus in which embodiments of the present invention can be applied. The camera comprises a lens 2 or other image forming element, which projects an image on a sensor 4. The image sensor 4 is connected to processing electronics 6, which reconstruct the image as a signal with primary colors red, green and blue (RGB). The primary color signals (RGB signal) is then input to a camera matrix 12, which corrects the RGB signal for errors in color caused by the difference in spectral characteristic between the sensor 4 and an ideal spectral characteristic. The camera matrix 12 is connected to a white balance circuit 14 for correcting the white balance of the image, e.g. to correct for a specific type of lighting.

In particular at low light levels the color noise of a digital camera, mainly caused by the analog image sensor 4 and its output amplifier, can become clearly visible. Depending on the heaviness of the color matrix 12 of the camera the color noise can be strongly amplified. Also the red and blue amplitude controls of the white balance circuit 14 can, as function of the color temperature of the scene, amplify the color noise even more. To correct for the camera color noise, the camera according to the present embodiment is equipped with a color noise reduction circuit 20, which modifies the RGB signal before further processing in the camera. The further processing in the camera comprises a gamma correction circuit 16, and a conversion unit 18 for outputting a suitable output signal (Y′, R′—Y′, B′—Y′), which are conventional elements of an image processing circuit. These circuit 16, 18 are known to the person skilled in the art and need no further detailed explanation here.

Color signals, e.g. as those provided by a digital camera, comprise three primary colors, red, green and blue (R, G, B), with a value for each of the component colors for each pixel of the image. The values of these component colors may be represented in a three dimensional color space, such as the UCS1976 3D color space. This 3D color space represents the three primary color components in a symmetrical manner, each having its own axis R, G, B, with e.g. the maximum value of the primary color signals on the vertical axis. Other parameters may be chosen on the vertical axis, e.g. the luminance value of the primary color signals

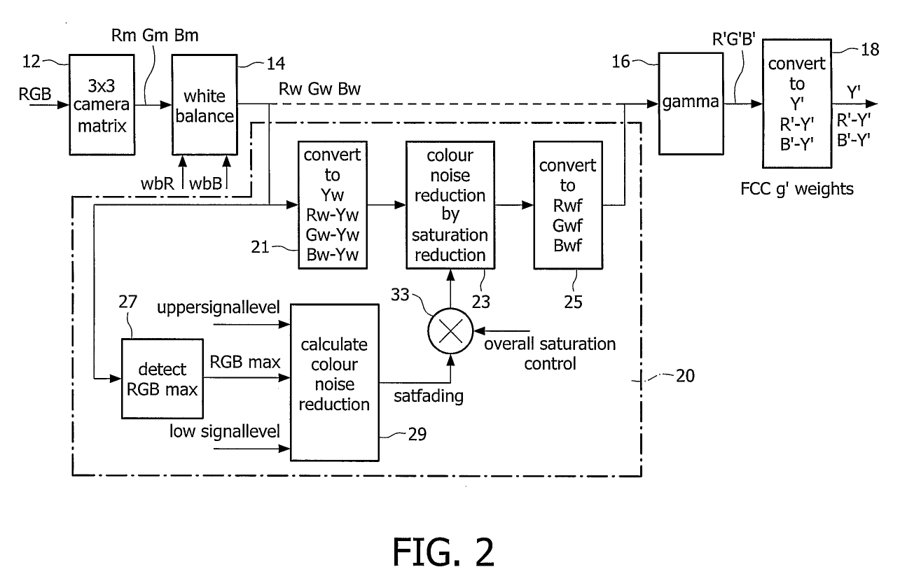

In FIG. 2, a first embodiment of the color noise reduction circuit 20 is shown in more detail in connection with the image processing elements of the camera of FIG. 1. A block diagram is shown of a color noise reduction scheme as function of RGBmax. The main signal path includes a first converter 21, a de-saturation circuit 23 and a second converter 25 for applying the color noise reduction. The first converter 21 translates the color signals after the camera matrix 12 and the white balance (WB) circuit 14 to a luminance signal Yw and color difference signals (Rw−Yw), (Gw−Yw) and (Bw−Yw). These signals are input to the de-saturation circuit 23 followed by a second converter 25 that realizes the red, blue, green primary signals (RwfGwfBwf) again.

In the figures, the character ‘m’ in the RGB signals indicates the signals output by the camera matrix 12. The character ‘w’ in the RGB signals stands for the signal after the white balance circuit 14 and the ‘f’ for the signal after the saturation fading or color noise reduction circuit 20.

Described with equations for the camera matrix and white balance counts:

Rw=Rm×wbR=(a11×R+a12×G+a13×B)×wbR

Gw=Gm=(a21×R+a22×G+a23×B)

Bw=Bm×wbB=(a31×R+a32×G+a33×B)×wbB

in which wbR and wbB are white balance parameters which are input to the white balance circuit 14, and a11, a12, a13, a21, a22, a23, a31, a32 and a33 are the parameters for the 3×3 camera matrix circuit 12.

For the Luminance signal Ym as output by the first converter 21 counts that:

Yw=Y_{R}×Rw+Y_{G}×Gw+Y_{B}×Bw=0.299×Rw+0.587×Gw+0.114×Bw.

The color difference signals with unity reduction factors are (Rw−Yw), (Gw−Yw) and (Bw−Yw).

The color noise reduction circuit 20 further comprises a circuit 27 for determining a characteristic value, e.g. the maximum value of the R, G and B components of the RGB signal according to:

RGBmax=max{Rw,Gw,Bw}

The parameter ‘satfading’ for controlling the color noise reduction, is calculated in a calculation unit 29 according to the following procedure:

### Procedure ColorNoiseReduction(Signaltype)

{Color noise reduction by de-saturation as f(Signaltype), e.g. RGBmax}
used variables:
uppersignallevel {upper level where de-saturation and color noise reduction starts}
lowersignallevel {lower level where the saturation and color noise have become zero}
satfading=1 {default setting, no color noise reduction}
if (Signaltype<uppersignallevel) and (Signaltype>lowersignallevel) then
satfading=1−((uppersignallevel−Signaltype)/(uppersignallevel−lowersignallevel))
else if Signaltype<=lowersignallevel then satfading=0
end {of procedure ColorNoiseReduction}

By substituting RGBmax for Signaltype in this procedure (ColorNoiseReduction(RGBmax), an RGBmax controlled noise/saturation reduction will be implemented. The parameters lowersignallevel, uppersignallevel and RGBmax are input to the calculation circuit 29, which then outputs the ‘satfading’ parameter.

For the color difference signals as calculated by the de-saturation circuit 23, the following formulas count:

(Rw−Yw)f=satfading×(Rw−Yw)

(Gw−Yw)f=satfading×(Gw−Yw)

(Bw−Yw)f=satfading×(Bw−Yw)

According to the procedure described above (ColorNoiseReduction (Signaltype)), for RGBmax>=uppersignallevel no color noise reduction happens at all because then satfading=1. For RGBmax<=lowersignallevel the satfading parameter is zero, resulting in a maximum of color noise reduction because the color difference signals (Rw−Yw)f, (Gw−Yw)f, (Bw−Yw)f, have become zero then. For RGBmax between the uppersignallevel and the lowersignallevel the satfading parameter gets a value between unity and zero. As a consequence also the amount of de-saturation will vary between 0% and 100%. The latter is a black and white signal without any color information.

The correction parameter ‘satfading’ may be multiplied by an ‘overall saturation control parameter’ using a multiplier 33 before being input to the de-saturation circuit 23. The ‘overall saturation control’ parameter in FIG. 2 is default unity but can for example be adjusted towards zero to obtain black and white images (for example for night shots) or, at a low camera noise, to increase the color saturation in the linear color space. It is to be noticed that the linear Luminance signal Yw remains unaffected as function of the color saturation.

The circuit as shown in FIG. 2 further comprises a second converter 25 for reconverting the processed signals to an RGB signal again. The output of second converter 25 is given by:

Rwf=(Rw−Yw)f+Yw

Gwf=(Gw−Yw)f+Yw

Bwf=(Bw−Yw)f+Yw,

which can be input to the gamma circuit 16 of the camera.

In a further embodiment, the first converter 23 is only arranged to determine the luminance signal Yw. By realizing the luminance signal Yw only and leaving out the three color difference signals, it is possible to combine the above equations at the cost of an extra multiplier {(1−satfading)*Yw}, the output of which will be used three times as an addition term:

Rwf=satfading*(Rw−Yw)+Yw=satfading*Rw+(1−satfading)*Yw

Gwf=satfading*(Gw−Yw)+Yw=satfading*Gw+(1−satfading)*Yw

Bwf=satfading*(Bw−Yw)+Yw=satfading*Bw+(1−satfading)*Yw

The parameters uppersignallevel and lowersignallevel may be chosen to obtain different results for the 3D color noise suppression. When the maximum range of the R, G or B signal is e.g. 255/255, the uppersignallevel may be chosen equal to 160/255, and the lowersignallevel may be chosen equal to 60/255. This results in a well balanced color noise reduction.

It is also possible to have the color saturation reduction to start already at the maximum RGB input level, e.g. by choosing uppersignallevel to be equal to 300/255. When the lowersignallevel is chosen to be equal to 100/255, the color saturation is already reduced at the maximum RGB input levels, and as a result, also the amount of color noise is reduced. It can be demonstrated that for the upper part of a color bar test image, where RGBmax=1.0 for all colors, the RGBmax value after the color de-saturation has been decreasing. The largest RGBmax amplitude decrease starts with the blue color, followed by respectively the red, magenta, green, cyan and yellow colors. The lowersignallevel has been adjusted to 100/255 (0.39), resulting in the de-saturation flow towards the gray centre of the lower part of the color bar test image.

Furthermore, with an adjustment range of lowersignallevel <0.0 it can be prevented that in the lower part of the color bar test image the colors become fully desaturated to the gray line in the centre of the color space. The parameter lowersignallevel can e.g. be set at −50/255 (−0.2) and uppersignallevel can e.g. be set to 70/255 (0.27).

In the above embodiment, the RGBmax color noise reduction starts at the same RGBmax input level of all colors. Assuming that the amount of noise of the three camera primary color sources is equal, this means that the RGBmax color noise reduction is not the optimum in case of a image taken in another environmental color temperature than daylight. In case of a reddish color temperature, after the camera white balance the blue signal will be amplified, so increasing the blue noise, while the red signal will be attenuated, resulting in a decrease of the red noise. As a consequence the blue color noise has not sufficiently been reduced and the red noise too much.

In a further embodiment of the present invention it is possible to adapt fictitiously the upper- and lowersignallevel of the RGBmax color noise reduction as function of the white balance parameters wbR and wbB. Depending on the red or the blue signal being the RGBmax signal after the white balance, the RGBmax signal can be adapted in such a way as if the uppersignallevel and lowersignallevel have been adapted.

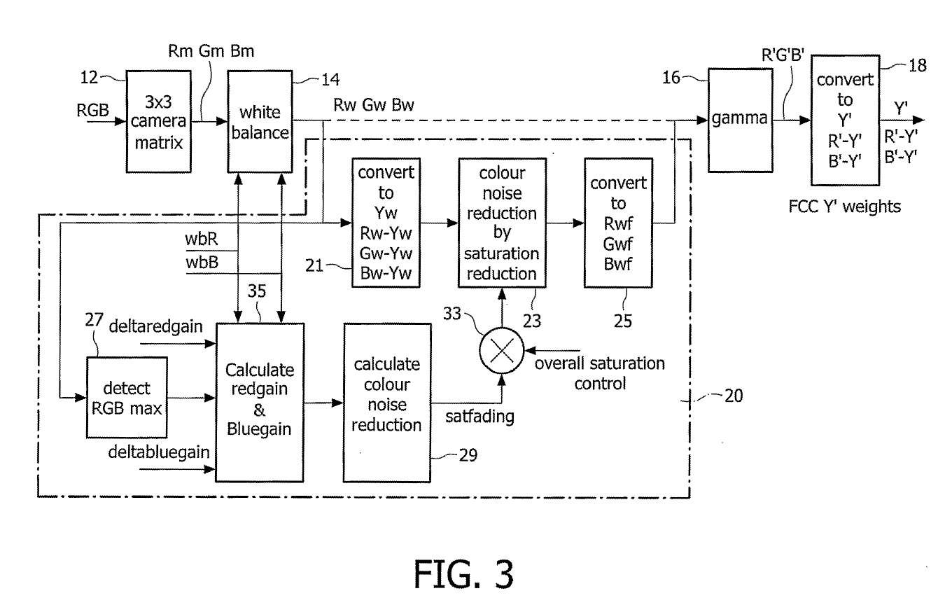

This improved method embodiment can e.g. be implemented in the color noise reduction circuit 20 embodiment as shown in FIG. 3. The embodiment shown in FIG. 3 is to a large extent identical to the embodiment shown in FIG. 2: elements with equal function have been indicated using like reference numerals. In this embodiment, the color noise reduction is implemented as a function of RGBmax and the white balance parameters wbR and wbB. After the RGBmax detection circuit 27, an additional calculator element 35 is introduced, which is arranged to calculate further parameters to be used in the noise reduction calculations for obtaining a smooth adaptation of the color noise reduction as function of white balance parameters wbR and wbB. The calculation of the ‘satfading’ parameter in the calculation circuit 29 concerns a comparable procedure as the ColorNoiseReduction procedure in the embodiment of FIG. 2, but has now been extended according to the WB_ColorNoiseReduction procedure:

### Procedure WB_ColorNoiseReduction

{Adaptive color noise reduction using the wbR and wbB white balance parameters}
if R=RGBmax then
ColorNoiseReduction(RGBmax/wbR) {adapt red noise reduction}
else if B=RGBmax then
ColorNoiseReduction(RGBmax/wbB) {adapt blue noise reduction}
else ColorNoiseReduction(RGBmax) {green noise reduction is unaltered}

Notice that the ColorNoiseReduction procedure is according to the procedure as described with the embodiment above (without using the white balance parameters).

In case of a reddish color circle image after the white balance, for R=RGBmax the upper- and lowersignallevels are fictitiously decreased by dividing RGBmax with a factor of 0.8. The color circle is an image comprising various colors in which transients between colors (in the three dimensional color space) can be made visible The increased (RGBmax/wbR) value results in less color de-saturation and consequently less noise reduction of the red colors. Because of the larger red signal in the reddish color circle, this is exactly what is desired. For B=RGBmax the upper- and lowersignallevels are fictitiously increased by dividing RGBmax with a factor of 1.3. Now the decreased (RGBmax/wbB) value results in a larger color de-saturation, so an increased color noise reduction of the blue colors. Note that RGBmax divided by wbR or wbB in relation to the uppersignallevel and lowersignallevel is the same as RGBmax in relation to the uppersignallevel and lowersignallevel multiplied with wbR or wbB.

This embodiment results in a discontinuity in the 3D color space (UCS1976) at each of the three complementary colors (magenta, cyan, yellow). This effect can be prevented using an even further embodiment of the present invention.

In this further embodiment, a different color noise reduction procedure is implemented in the color noise reduction circuit 20:

### Procedure RedgainBluegain_ColorNoiseReduction

{Adaptive color noise reduction using the Redgain and Bluegain functions}
begin
if wbR>wbB then {images with a high color temperature}
begin
if G=RGBmax then ColorNoiseReduction(RGBmax)
else if B=RGBmax then ColorNoiseReduction(RGBmax×Bluegain)
else if R=RGBmax then ColorNoiseReduction(RGBmax/Redgain)
end
else if wbB>wbR then {images with a low color temperature}
begin
if G=RGBmax then ColorNoiseReduction(RGBmax)
else if B=RGBmax then ColorNoiseReduction(RGBmax/Bluegain)
else if R=RGBmax then ColorNoiseReduction(RGBmax×Redgain)
end
else ColorNoiseReduction(RGBmax) {no white balance adaptation}
end {of procedure RedgainBluegain_ColorNoiseReduction}

For the green color the amount of color de-saturation is independent of the white balance parameters wbR and wbB. For the red and blue colors dividing with or multiplying by Redgain, respectively Bluegain, depends on a low or high color temperature of the scene.

In this procedure, a number of further procedures are used to obtain the parameters Bluegain and Redgain. With the aid of two easy to realize functions in the UCS1976 color space the turn over of the red and blue area has become possible.

### Function Redgain

(Redgain is the result of the smooth red turn over of an arbitrary color}
used variables:
deltaredgain {the direction and the amount of red area turning over}
begin {of procedure Redgain}
if (R=RGBmax) then
begin {colors within the triangle White-Ye-Ma}
{calculate RGBsat first}
if RGBmax>0 then RGBsat=(RGBmax−RGBmin)/RGBmax else RGBsat=0
{calculate Redgain}
if G>=R then Redgain=1+(deltaredgain×RGBsat×(RGBmax−G)/RGBmax)
else if B>G then Redgain=1+(deltaredgain×RGBsat×(RGBmax−B)/RGBmax)
end
end {of procedure Redgain}

### Function Bluegain

(Bluegain is the result of the smooth blue turn over of an arbitrary color}
used variables:
deltabluegain {the direction and the amount of blue area turning over}
begin {of procedure Bluegain}
if (B=RGBmax) then
begin {colors within the triangle White-Cy-Ma}
{calculate RGBsat first}
if RGBmax>0 then RGB sat=(RGBmax−RGBmin)/RGBmax else RGB sat=0
{calculate Bluegain}
if G>=R then Bluegain=1+(deltabluegain×RGBsat×(RGBmax−G)/RGBmax)
else if B>G then Bluegain=1+(deltabluegain×RGBsat×(RGBmax−R)/RGBmax)
end
end {of procedure Bluegain}

With the aid of the functions Redgain and Bluegain, it is possible to obtain a smoothing turn over. It has been verified that in the color circle image at the top no discontinuity at the three complementary colors can be seen. Neither a discontinuity can be seen in the 2D Chrominance and UCS1976 planes at the left side, nor the 3D UCS1976 color space at the right side. E.g., the color saturation increase for R=RGBmax and the saturation decrease for B=RGBmax with deltaredgain=deltabluegain=0.4, have been obtained as follows:

if B=RGBmax then sat=1/Bluegain

else if R=RGBmax then sat=1×Redgain,

where sat represents the color saturation control.

The result of this saturation control is that for R=1 and G=B=0 the maximum color saturation has been 1.4 times increased, while for B=1 and G=R=0 the maximum saturation has been 1.4 times decreased. For all other RGB values of the color circle the saturation control will smoothly vary between a saturation of 1/1.4 and 1.4.

The parameters deltaredgain and deltabluegain can be adapted. E.g. in the case of adaptation of a white balance for a low color temperature scene, for turning over the red area, i.e. R=RGBmax, deltaredgain has been adjusted to 1.0 and for turning over the blue area, i.e. B=RGBmax, deltabluegain to 1.5. From practical testes, it can be seen that the red noise reduction (or color de-saturation) has decreased while the blue noise reduction has increased, starting already for B=RGBmax=1.0.

It is to be noticed that the deltaredgain and deltabluegain adjustments need not to be proportionally to the white balance parameters wbR and wbB. One reason is that also the noise contribution of the camera matrix can be taken into account. Another reason is that the relation between wbR and deltaredgain at one side and wbB and deltabluegain at the other site, need to be determined in practice.

It is noted that these smooth transitions may be applied as well in other image processing methods, but with another purpose, such as enhancing a specific color, e.g. for detection of a skin tone.

In practical examples, e.g. in case of a CMOS camera image, that has been taken at low environmental light conditions and a color temperature of 3200K, in the reddish color environment there is a large lack of blue signal, resulting here in a strong blue colored noise spread out over the whole image.

By means of applying the RGBmax color noise reduction with the uppersignallevel adjusted to 140 and the lowersignallevel to 50, a reduction of especially the blue, but also of the green and red noise will be obtained.

When the white balance parameters have been involved for an extra reduction of the blue color noise and less reduction of the red noise, the extra reduction of the blue color noise also decreases the lower light blue colors, while the smaller red noise reduction causes a small increase of the lower light red colors.

1. Method for reducing color noise in a digital image having primary color signals (R; G; B), the method comprising:
determining a maximum signal value (Signaltype) from the primary color signals;
reducing a color saturation of the digital image by modifying the primary color signals or signals related to the primary color signals depending on the maximum signal value (Signaltype), in which the color saturation is reduced at least for low values of the primary color signals or signals related thereto.

2. Method according to claim 1, in which modifying the primary color signals or signals related to the primary color signals comprises:
multiplying with a fading factor (satfading), in which the fading factor is a function dependent on the maximum signal value (Signaltype), determined by:
satfading=1−((uppersignallevel−Signaltype)/(uppersignallevel−lowersignallevel)), if the maximum signal value Signaltype is smaller than uppersignallevel and larger than lowersignallevel;
and by
satfading=0, if the maximum signal value Signaltype is lower than or equal to lowersignallevel,
in which the parameter uppersignallevel is a predetermined upper level where de-saturation and color noise reduction starts, and the parameter lowersignallevel is a predetermined lower level where saturation and color noise have become zero.

3. Method according to claim 2, in which the fading factor is multiplied with an additional multiplier factor.

4. Method according to claim 2, in which the value of the parameter uppersignallevel is larger than a maximum possible primary color signal level.

5. Method according to claim 2, in which the value of the parameter lowersignallevel is smaller than a minimum possible primary color signal level.

6. Method according to claim 1, in which the maximum signal value (Signaltype) is a maximum value (RGBmax) of the primary color signals.

7. Method according to claim 1, in which the maximum signal value (Signaltype) is a maximum value (RGBmax) of the primary color signals multiplied by a white balance signal factor.

8. Method according to claim 7, in which
in case of a white balance correction of the image to a lower color temperature, the white balance signal factor is equal to:
one if the maximum value (RGBmax) of the primary color signals is the green component signal G;
Bluegain if the maximum value (RGBmax) of the primary color signals is the blue component signal B; and
1/Redgain if the maximum value (RGBmax) of the primary color signals is the red component signal R;
in case of a white balance correction of the image to a higher color temperature the white balance signal factor is equal to:
one if the maximum value (RGBmax) of the primary color signals is the green component signal G;
1/Bluegain if the maximum value (RGBmax) of the primary color signals is the blue component signal B; and
Redgain if the maximum value (RGBmax) of the primary color signals is the red component signal R;
and in case of no white balance correction, the white balance signal factor is equal to one;
in which Bluegain and Redgain are parameters depending on the primary color signals and white balance correction parameters for obtaining a smooth adaptation of the color noise reduction.

9. Method according to claim 8, in which the parameter Bluegain is calculated according to:
if G>=R then Bluegain=1+(deltabluegain×RGBsat×(RGBmax−G)/RGBmax);
if B>G then Bluegain=1+(deltabluegain×RGBsat×(RGBmax−B)/RGBmax);
in which R, G and B are the color signal values in the white-cyan-magenta triangle of the three dimensional color space,
RGBsat is a saturation parameter according to RGBsat=(RGBmax−RGBmin)/RGBmax, in which RGBmax is the maximum value in the primary color signals and RGBmin is the minimum value in the primary color signal, and deltabluegain is a predetermined parameter.

10. Method according to claim 8, in which the parameter Redgain is calculated according to:
if G>=R then Redgain=1+(deltaredgain×RGBsat×(RGBmax−G)/RGBmax);
if B>G then Redgain=1+(deltaredgain×RGBsat×(RGBmax−R)/RGBmax);
in which R, G and B are the color signal values in the white-yellow-magenta triangle of the three dimensional color space,
RGBsat is a saturation parameter according to RGBsat=(RGBmax−RGBmin)/RGBmax, in which RGBmax is the maximum value in the primary color signal and RGBmin is the minimum value in the primary color signal, and deltaredgain is a predetermined parameter.

11. Image color noise reduction circuit (20) for processing a digital image having primary color signals (R; G; B), the image color noise reduction circuit comprising:
a determination circuit (27) for determining a maximum signal value (Signaltype) from the primary color signals and a calculation circuit (29) connected to the determination circuit (27) for reducing a color saturation of the digital image by modifying the primary color signals or signals related thereto depending on the maximum signal value, in which the color saturation is reduced at least for low values of the primary color signals or signals related thereto.

12. Digital camera comprising a digital image sensor (2), processing electronics (12, 14) for processing the digital image from the digital image sensor (2) and an image color noise reduction circuit according to claim 11.
